(19) United States
(12) Patent Application Publication
(10) Pub. No.: US 2025/0075623 A1
(43) Pub. Date: Mar. 6, 2025

(54) ROTOR BLADES WITH PASSAGEWAYS

(71) Applicant: General Electric Company, Schenectady, NY (US)

(72) Inventors: Tsuguji Nakano, West Chester, OH (US); Andrew Breeze-Stringfellow, Montgomery, OH (US)

(21) Appl. No.: 18/242,079

(22) Filed: Sep. 5, 2023

(51) Int. Cl. F01D 5/16; F01D 5/14

(52) U.S. Cl. CPC F01D 5/16; F01D 5/147; F05D 2220/323; F05D 2240/30; F05D 2260/96

(57) ABSTRACT

A rotor blade comprises an elongated body that has a pressure side and a suction side. The pressure side and suction side intersect at a leading edge and a trailing edge. The elongated body extends outward from a rotor hub. A span is described by a first straight line distance extending outward from the rotor hub along the elongated body. A chord of the elongated body is defined by a second straight-line distance extending between the leading edge and the trailing edge. At least one passageway extends through the elongated body between the pressure side and the suction side allowing a corrective flow of air to move from the pressure side to the suction side. The corrective flow of air interacts with and energizes low momentum airflow occurring along the suction side.

### TECHNICAL FIELD

The technical field relates to rotor blades and, more specifically, to rotor blade structures used in aircraft propulsion devices.

### BACKGROUND

Aircraft propulsion devices (e.g., engines) use various kinds of rotor blades or airfoils. Various problems sometimes can occur with the blades over time. One example of such a problem is flutter. Flutter refers to vibrations that are created in the blade by low momentum air moving about one or more surfaces of the blade. Flutter can damage the rotor blade or cause the blade to fail. This damage may result in the inoperability and failure of the entire engine and potentially cause catastrophic results.

### BRIEF DESCRIPTION OF THE DRAWINGS

Various needs are at least partially met through provision of rotor blade structures that reduce or eliminate flutter or otherwise extend the incidence range, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 comprises a diagram of a rotor blade in accordance with various embodiments of these teachings;

FIG. 2 comprises a cross-sectional view of the rotor blade of FIG. 1 in accordance with various embodiments of these teachings;

FIG. 3 comprises a cross-sectional view of the rotor blade of FIG. 1 showing the skew of a passageway in accordance with various embodiments of these teachings;

FIG. 4A shows a first state of a rotor blade during operation in accordance with various embodiments of these teachings;

FIG. 4B shows a second state of a rotor blade during operation in accordance with various embodiments of these teachings;

FIG. 4C shows a third state of a rotor blade during operation in accordance with various embodiments of these teachings;

FIG. 5 comprises a diagram of a rotor blade with multiple passageways in accordance with various embodiments of these teachings;

FIG. 6 comprises a cross-sectional view of an unducted engine in accordance with various embodiments of these teachings;

FIG. 7 comprises a flowchart describing an operation or testing approach in accordance with various embodiments of these teachings;

FIG. 8A, FIG. 8B, and FIG. 8C comprise diagrams of rotor blades having passageways with multiple entrances and/or exits in accordance with various aspects of these teachings;

FIG. 9 comprises a cross-sectional view of part of an engine assembly in accordance with various embodiments of these teachings;

FIG. 10 comprises a cross-sectional view of a gas turbine engine in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

In the present approaches, passageways are provided between the pressure side and the suction side of rotor blades of propulsion devices (e.g., aircraft engines). Advantageously, the strategic placement of these passageways mitigates or eliminates flutter in the blades by energizing low momentum or low energy air on the suction sides of the rotor blades. The approaches provided herein are applicable to ducted or unducted rotor configurations and are not limited to particular engine types or configurations. Advantageously, these approaches improve rotor blade distortion tolerances allowing shorter inlets for the engine to be used. In other advantages, the passageways can be used to improve the aspect ratio of the rotor blade or can be formed in the rotor blade as flutter issues are detected when testing the rotor blade.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

The foregoing and other benefits may become clearer upon making a thorough review and study of the following detailed description.

The approaches described herein relate to rotor blades of all types. It will be appreciated that fan blades are a specific type of rotor blade. More specifically, a fan blade is typically used on rotor at the front of the unducted thrust producing device (e.g., engine) to create thrust and these approaches are particularly advantageous when used with fan blades.

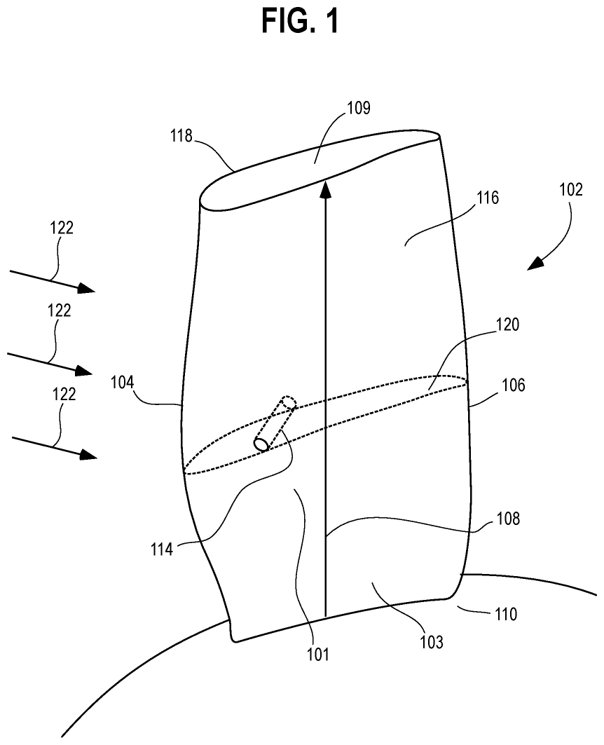

Referring now to FIG. 1, one example of a rotor blade having passageways extending through the rotor blade is described. A rotor blade 102 comprises an elongated body 101 with a pressure side 116 and a suction side 118. The pressure side 116 and the suction side 118 intersect at a leading edge 104 and a trailing edge 106. A root (or root section) 103 of the rotor blade 102 is coupled to a rotor hub 110. A span 108 is defined as a straight-line distance across the rotor blade 102 and extends outward from the rotor hub 110 to a tip surface (or tip) 109. Any given position along the span 108 is given as a percentage value (%) from 0 to 100. The 0% value of the span 108 is at the rotor hub 110 while the 100% position on the span 108 occurs at the tip surface (or tip) 109 of the rotor blade 102.

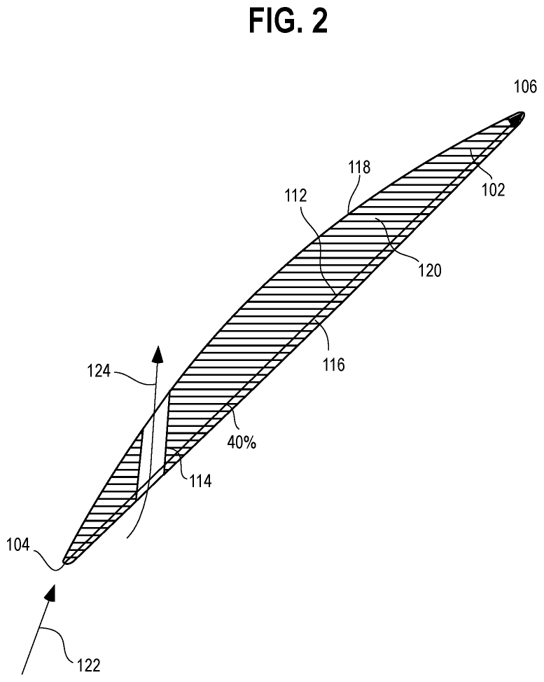

As shown in a cross-sectional view of the rotor blade 102 in FIG. 2, a chord 112 of the rotor blade 102 is defined as a straight-line distance extending between the leading edge 104 and the trailing edge 106. Positions along the chord 112 are defined by percentage values (%) from 0 to 100. The 0% value of the chord 112 is at the leading edge 104 while the 100% position on the chord 112 is at the trailing edge 106. The 40% location of the chord is shown in FIG. 2.

An incoming airflow 122 arrives at the leading edge 104 first. The incoming airflow 122 moves around the rotor blade 102 and eventually past the trailing edge 106. As the incoming airflow 122 flows around the rotor blade 102, different pressures can develop on either side of the rotor blade 102. For example, a higher pressure may develop on the pressure side 116 as compared to the suction side 118 of the rotor blade 102.

Referring again to FIG. 1, the rotor hub 110 is structured to hold the rotor blade 102 and rotates about an axis. The rotor hub 110 also is coupled to other rotor blades (for simplicity, not shown in FIG. 1). The root 103 of the elongated body 101 of the rotor blade 102 is coupled to or otherwise connected to the rotor hub 110. The rotor hub 110 is rotatable thereby moving all rotor blades connected to the rotor hub 110. As the rotor hub 110 turns, it moves or draws the incoming airflow 122 about the rotor blade 102.

The rotor hub 110 can be used with all types of propulsion devices such as aircraft engines. In some examples, rotor blade 102 and the rotor hub 110 are parts of an unducted engine with a forward rotating blade assembly and an aft stationary blade assembly. The rotor hub 110 may be deployed as either the forward rotating blade assembly or the aft stationary blade assembly. However, other configurations are possible. For example, instead of being a forward rotating blade assembly and an aft stationary blade assembly, the two blade assemblies could be counter-rotating with respect to one another. As another example, the forward blade assembly could be stationary and the aft blade assembly could be rotating.

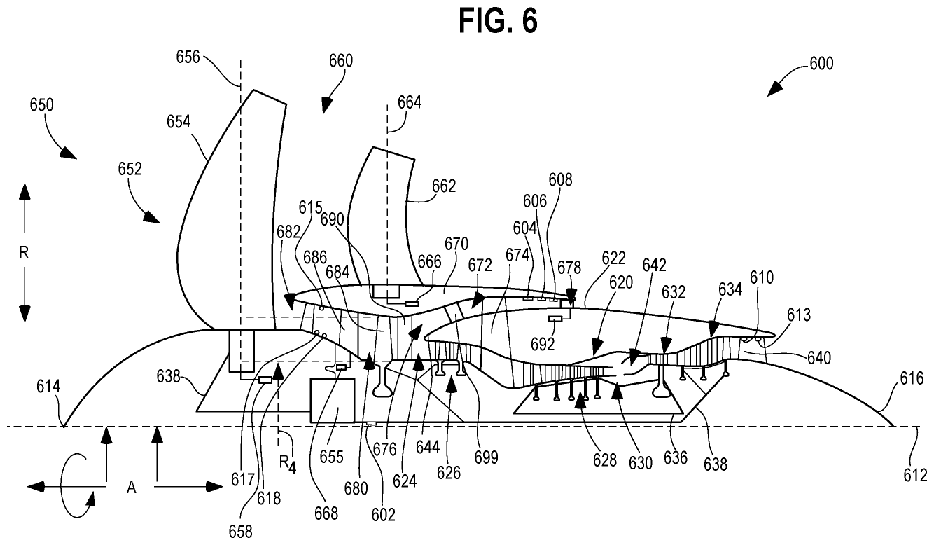

With an unducted engine, there is no duct or cover surrounding the rotor blades. It will be appreciated that these approaches could also be utilized in ducted engines where a duct or cover also surrounds the rotor blades. FIG. 6 (described below) describes one example of an unducted engine. A ducted engine would be similar to the example of FIG. 6 but also have a duct surrounding the rotor blades.

Referring to FIGS. 1 and 2, a passageway 114 extends between the pressure side 116 the suction side 118 of the rotor blade 102. During operation, incoming airflow 122 drawn by the rotation of the rotor hub 110 approaches the leading edge 104, then moves around the pressure side 116 and the suction side 118 of the rotor blade 102. As the incoming airflow 122 moves along the suction side 118, the incoming airflow 122 may have low momentum or energy as compared to the air on the pressure side 116. This may eventually cause flutter in the rotor blade 102. In other words, low momentum air present on the suction side 118 of the rotor blade 102 can eventually create flutter in the rotor blade 102 and the flutter may damage and/or destroys the rotor blade 102. As described elsewhere herein, one or more passageways 114 are formed in the rotor blade 102 with the exact number determined by automated or manual analysis of the rotor blade 102 considering the individual effectiveness of each passageway 114 and the cumulative effect of all passageways 114 at energizing low momentum air.

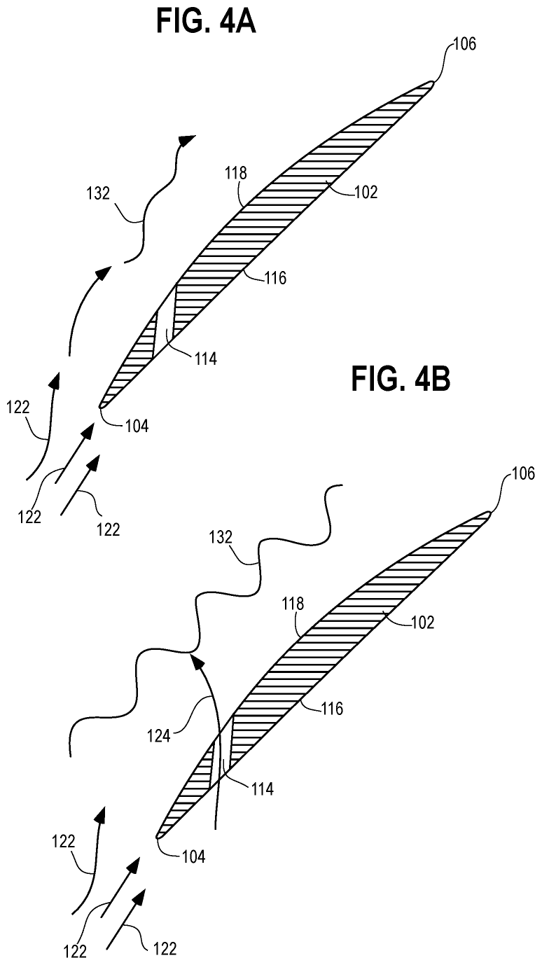

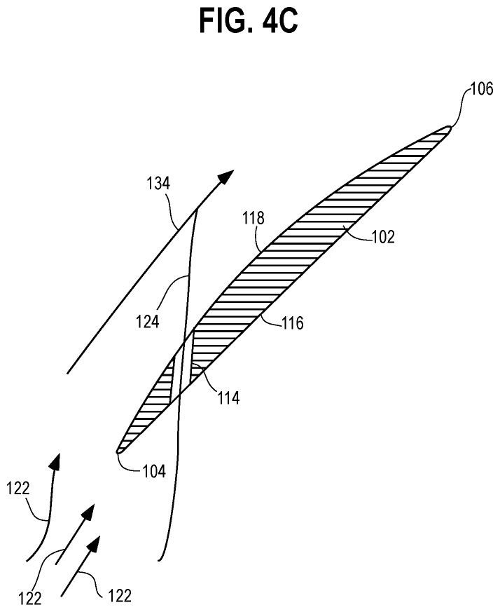

The passageway 114 allows a corrective airflow 124 to move or flow from the pressure side 116 to the suction side 118 of the rotor blade 102. The corrective airflow 124 after moving through the passageway 114 impacts or interacts with the low momentum air on the suction side 118 of the rotor blade 102 and adds energy to (energizes) the low momentum air. By “energize” and as used herein, it is meant that the corrective airflow 124 replenishes, refreshes, bolsters, adds energy, and/or supplements the airflow on the suction side 118. With this added energy, the low momentum air will no longer split, move backwards, or otherwise cause flutter in the rotor blade 102. Consequently, the flutter is reduced or eliminated in the rotor blade 102 because low momentum air on the suction side 118 is no longer adversely impacting or interacting with the rotor blade 102. This process is described in greater detail below with respect to FIGS. 4A, 4B, and 4C.

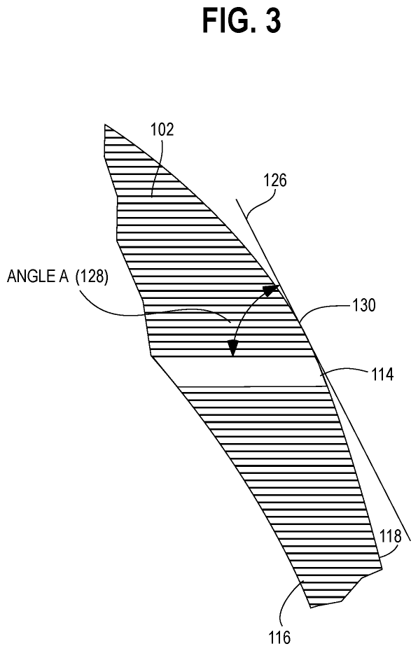

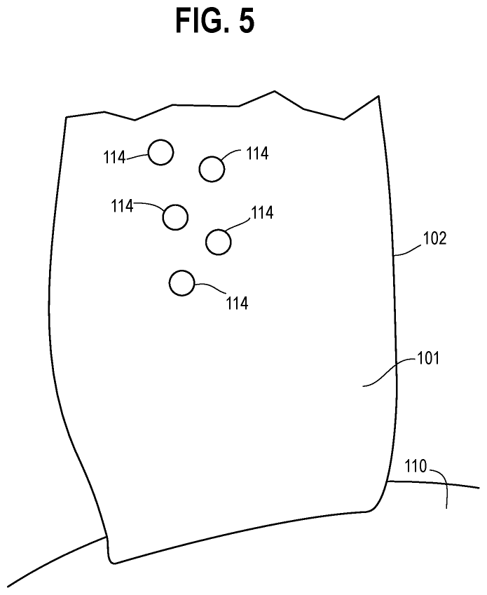

Various sizes, dimensions, and placements of the passageway 114 are possible. In one particularly advantageous example, the passageway 114 is located at a position of between 0% and 40% of the chord 112, at a position greater than 40% of the span 108 (between 40% and 100% of the span), with the passageway 114 being a round hole having a diameter from 0.01% to 1% of the diameter of the rotor blade 102, where the diameter of the rotor blade 102 is defined to be a diameter of a circle defined by the tip of the moving rotor blades. In other examples, the passageway 114 is greater than 50 percent of the chord. Multiple passageways can also be used as described below with respect to FIG. 5. As described with respect to FIG. 3, an angle (or skew angle) of the passageway 114 (as measured from a line tangent from a point along the suction side 118) can also vary. The passageway 114 can have a circular cross section, but other cross-sectional shapes (square, rectangular, trapezoidal, elliptical to mention a few) are also possible. The passageway 114 may be formed during the manufacturing process by drilling or some other suitable technique. The passageways may be formed by other processes such as additive processes as well.

These approaches improve the flutter margin with less in the way of efficiency penalties compared to previous rotor blade designs. In other aspects, these approaches allow speed ranges at the tip surface 109 (FIG. 1) to be 500-1800 ft/second. Advantageously, these approaches also reduce aspect rations and improve distortion tolerances allowing potentially shorter inlets to be used with the engines.

Referring now to FIG. 2, a cross sectional surface 120 is shown. It can be seen that the passageway 114 extends from the pressure side 116 to the suction side 118 of the rotor blade 102. During operation, the corrective airflow 124 moves from the pressure side 116 to the suction side 118 of the rotor blade 102. Once the corrective air reaches the suction side 118, then it impacts with or interacts with low momentum air on the suction side 118. The interaction adds enough energy to the low momentum air so that the low momentum air will not separate, reverse, or otherwise flow in a way that would cause flutter to occur in the rotor blade 102.

Referring now to FIG. 3, one example of how the angle of the passageway 114 can be adjusted is described. A line 126 is tangent at a point 130 on the suction side 118 of the rotor blade 102. An angle A (128) describes the angle taken by the passageway 114 with respect to the line 126. In examples, the angle A (128) is called a skew angle and varies from 5 degrees to 175 degrees.

Although a single rotor blade 102 is shown, it will be appreciated that other rotor blades are coupled to the rotor hub 110 and may have passageways with parameters that are identical or very similar to the parameters that have been described. However, in other examples, these parameters might vary as between different blades.

Referring now to FIG. 4A, FIG. 4B, and FIG. 4C, examples of how the present approaches work to add energy to low momentum air on the suction side 118 of the rotor blade 102 are described.

Referring now to FIG. 4A, an initial state of the rotor blade 102 is shown. The rotor hub 110 (FIG. 1) is rotated and the airflow 122 flows toward the leading edge 104 of the rotor blade 102 and flows over the pressure side 116 and the suction side 118. Low momentum air 132 forms on the suction side (along the suction side 118). The low momentum air 132 may be air that backs up, swirls, or otherwise has resultant physical properties or flow directions that cause flutter to be created in the rotor blade 102.

Referring now to FIG. 4B, a second state of the rotor blade 102 is described that occurs after the first state. Corrective air 124 flows through the passageway 114 from the pressure side 116 to the suction side 118. The corrective air 124 impacts or interacts with the low momentum air 132 that has formed on the suction side 118. FIG. 4B shows the state of the system before the low momentum air 132 has been energized by the corrective air 124.

Referring now to FIG. 4C, a third state of the rotor blade 102 is shown that occurs after the second state. The corrective air 124 has impacted or interacted with the low momentum air 132 (FIGS. 4A and 4B) and caused the low momentum air 132 to change to an energized airflow 134. Since the airflows on both the pressure side 116 and suction side 118 are sufficiently energized, flutter is not created in the rotor blade 102 (or at least, significantly reduced so that it would not damage or destroy the rotor blade 102).

Referring now to FIG. 5, one example of where the rotor blade 102 has multiple passageways 114 is described. In the example of FIG. 5, multiple passageways 114 are formed through the elongated body 101. In this example, there are five passageways 114. These passageways 114 may be of the same dimensions or shapes. The passageways 114 are at different locations (a different span or a different chord position). The dimensions and/or skew angle of each of the passageways 114 may be the same or different. In other aspects, the passageways 114 can also skew (or be angled) radially (upward or downward rather than straight) as they cross between the pressure side 116 and the suction side 118.

The multiple passageways 114 may be incorporated into the rotor blade 102 as the result of an automated testing process. For example, an automated testing simulator (e.g., a simulator software program) may be used to test the placement of one passageway 114 through the rotor blade 102. The testing may determine whether flutter is created and/or how much flutter is created by positioning a passageway 114 at a particular location, with a particular angle A (128) or skew angle, and/or having particular shapes or dimensions on the rotor blade 102. After the first passageway 114 is incorporated and results determined in this automated process, then changes can be made. For example, the passageway 114 may be moved and/or additional passageways 114 added. The simulation may be run again and the results determined. If there is still enough flutter, then further changes (e.g., adding another passageway 114) may be made and further simulations made. This simulation process may be repeated until flutter has been eliminated (or reduced to a predetermined level that is acceptable). In this case, five passageways 114 have been found to be optimal.

Referring now to FIG. 6, one example of an unducted aircraft engine used in these approaches is described. The technology described with respect to the engine of FIG. 6 relates to an unducted propulsion system, particularly the shape of an external surface of one or more housings encasing a propulsion system, for which housings can be comprised of a spinner, hub and/or nacelle. It will be appreciated that the engine architecture of FIG. 6 is one example and that other examples are possible. Further, these approaches are applicable to ducted engines where a duct or cover encloses the fan blades.

A turbofan engine operates on the principle that a central gas turbine core drives a bypass fan, the fan being located at a radial location between a fan duct and the engine core. An unducted propulsion system instead operates on the principle of having the bypass fan located outside of the engine nacelle. This permits the use of larger fan blades able to act upon a larger volume of air than for a turbofan engine, and thereby improves propulsive efficiency over conventional engine designs.

Unducted propulsion systems may take the form of a propeller system, as used on a wide range of aircraft, e.g., radio-controlled model airplanes, drones, piston engine propeller aircraft, turboprop regional aircraft, and large turboprop military transports. Another type of unducted propulsion system, sometimes referred to as “open rotor”, consists of two blade assemblies, one in a forward position and one in an aft position, in which at least one of them rotates about an axis to deliver power to the propulsive stream that generates thrust. Such two blade assembly systems offer some advantages, but also some challenges and are far less common than single blade row systems. As used with respect to FIG. 6, the term “propeller” may refer to the single blade assembly of an unducted propulsion system or the forward blade assembly of an unducted propulsion system comprised of two blade assemblies. As used with respect to FIG. 6, the term “fan” may refer to either a propeller or both blade assemblies of an unducted propulsion system.

In FIG. 6, a schematic cross-sectional view of a gas turbine engine is provided, and this type of engine can be utilized in any of the approaches or as any of the engines described herein. Particularly, FIG. 6 provides an engine having a rotor assembly with a single stage of unducted rotor blades. In such a manner, the rotor assembly may be referred to herein as an “unducted fan,” or the entire engine 600 may be referred to as an “unducted aircraft engine.” In addition, the engine of FIG. 6 includes a third stream extending from the compressor section to a rotor assembly flow path over the turbomachine, as will be explained in more detail below.

For reference, the engine 600 defines an axial direction A, a radial direction R, and a circumferential direction C. Moreover, the engine 600 defines an axial centerline or central axis 612 that extends along the axial direction A. In general, the axial direction A extends parallel to the central axis 612, the radial direction R extends outward from and inward to the central axis 612 in a direction orthogonal to the axial direction A, and the circumferential direction extends three hundred sixty degrees (360°) around the central axis 612. The engine 600 extends between a forward end 614 and an aft end 616, e.g., along the axial direction A.

The engine 600 includes a turbomachine 620 and a rotor assembly, also referred to as a fan section 650, positioned upstream thereof. Generally, the turbomachine 620 includes, in serial flow order, a compressor section, a combustion section, a turbine section, and an exhaust defines an annular core inlet 624. A core cowl 622 further encloses at least in part a low-pressure system and a high-pressure system. For example, the core cowl 622 depicted encloses and supports at least in part a booster or low-pressure (“LP”) compressor 626 for pressurizing the air that enters the turbomachine 620 through the annular core inlet 624. A high-pressure (“HP”), multi-stage, axial-flow compressor 628 receives pressurized air from the LP compressor 626 and further increases the pressure of the air. The pressurized air stream flows downstream to a combustor 630 of the combustion section where fuel is injected into the pressurized air stream and ignited to raise the temperature and energy level of the pressurized air.

It will be appreciated that as used herein, the terms “high/low speed” and “high/low-pressure” are used with respect to the high-pressure/high-speed system and low-pressure/low-speed system interchangeably. Further, it will be appreciated that the terms “high” and “low” are used in this same context to distinguish the two systems and are not meant to imply any absolute speed and/or pressure values.

The high energy combustion products flow from the combustor 630 downstream to a high-pressure turbine 632. The high-pressure turbine 632 drives the HP compressor 628 through a high-pressure shaft 636. In this regard, the high-pressure turbine 632 is drivingly coupled with the HP compressor 628. The high energy combustion products then flow to a low-pressure turbine 634. The low-pressure turbine 634 drives the LP compressor 626 and components of the fan section 650 through a low-pressure shaft 638. In this regard, the low-pressure turbine 634 is drivingly coupled with the LP compressor 626 and components of the fan section 650. The LP shaft 638 is coaxial with the HP shaft 636 in this example embodiment. After driving each of the turbines 632, 634, the combustion products exit the turbomachine 620 through a turbomachine exhaust nozzle 640. Any blades associated with the LP compressor 626 and the HP compressor 628 may have passageways as described herein.

Accordingly, the turbomachine 620 defines a working gas flow path or core duct 642 that extends between the annular core inlet 624 and the turbomachine exhaust nozzle 640. The core duct 642 is an annular duct positioned generally inward of the core cowl 622 along the radial direction R. The core duct 642 (e.g., the working gas flow path through the turbomachine 620) may be referred to as a second stream.

The fan section 650 includes a fan 652, which is the primary fan in this example embodiment. For the depicted embodiment of FIG. 6, the fan 652 is an open rotor or unducted fan. As depicted, the fan 652 includes an array of fan blades 654 (only one shown in FIG. 6). The fan blades 654 are rotatable, e.g., about the central axis 612. As noted above, the fan 652 is drivingly coupled with the low-pressure turbine 634 via the LP shaft 638. For the embodiments shown in FIG. 6, the fan 652 is coupled with the LP shaft 638 via a speed reduction gearbox 655, e.g., in an indirect-drive or geared-drive configuration. The fan blades 654 may have passages 114 included as described herein.

Moreover, the fan blades 654 can be arranged in equal spacing around the central axis 612. Each blade 654 has a root and a tip surface and a span defined therebetween.

Moreover, each blade 654 defines a central blade axis 656. For this embodiment, each blade 654 of the fan 652 is rotatable about their respective central blades axis 656, e.g., in unison with one another. One or more actuators 658 are provided to facilitate such rotation and therefore may be used to change the pitch of the blades 654 about their respective central blades axis 656.

The fan section 650 further includes a fan guide vane array 660 that includes fan guide vanes 662 (only one shown in FIG. 6) disposed around the central axis 612. For this embodiment, the fan guide vanes 662 are not rotatable about the central axis 612. Each fan guide vane 662 has a root and a tip surface and a span defined therebetween. The fan guide vanes 662 may be unshrouded as shown in FIG. 6 or, alternatively, may be shrouded, e.g., by an annular shroud spaced outward from the tips of the fan guide vanes 662 along the radial direction R or attached to the fan guide vanes 662.

Each fan guide vane 662 defines a central blade axis 664. For this embodiment, each fan guide vane 662 of the fan guide vane array 660 is rotatable about their respective central blades axis 664, e.g., in unison with one another. One or more actuators 666 are provided to facilitate such rotation and therefore may be used to change a pitch of the fan guide vane 662 about their respective central blades axis 664. However, in other embodiments, each fan guide vane 662 may be fixed or unable to be pitched about its central blade axis 664. The fan guide vanes 662 are mounted to a fan cowl 670.

As shown in FIG. 6, in addition to the fan 652, which is unducted, a ducted fan 684 is included aft of the fan 652, such that the engine 600 includes both a ducted and an unducted fan which both serve to generate thrust through the movement of air without passage through at least a portion of the turbomachine 620 (e.g., without passage through the HP compressor 628 and combustion section for the embodiment depicted). The ducted fan is rotatable at about the same axis as the fan blade 654. The ducted fan 684 is, for the embodiment depicted, driven by the low-pressure turbine 634 (e.g., coupled to the LP shaft 638). In the embodiment depicted, as noted above, the fan 652 may be referred to as the primary fan, and the ducted fan 684 may be referred to as a secondary fan. It will be appreciated that these terms “primary” and “secondary” are terms of convenience, and do not imply any particular importance, power, or the like.

The ducted fan 684 includes a plurality of fan blades (not separately labeled in FIG. 6). The fan blades of the ducted fan 684 can be arranged in equal spacing around the central axis 612. Each blade of the ducted fan 684 has a root and a tip surface and a span defined therebetween. Passageways 114 as described herein may be applied to the fan blades of the ducted fan 684.

The fan cowl 670 annularly encases at least a portion of the core cowl 622 and is generally positioned outward of at least a portion of the core cowl 622 along the radial direction R. Particularly, a downstream section of the fan cowl 670 extends over a forward portion of the core cowl 622 to define a fan flow path or fan duct 672. According to this aspect, the fan flow path or fan duct 672 may be understood as forming at least a portion of the third stream of the engine 600.

Incoming air may enter the fan duct 672 through a fan duct inlet 676 and may exit through a fan exhaust nozzle 678 to produce propulsive thrust. The fan duct 672 is an annular duct positioned generally outward of the core duct 642 along the radial direction R. The fan cowl 670 and the core cowl 622 are connected together and supported by a plurality of substantially radially extending, circumferentially spaced stationary struts 674 (only one shown in FIG. 6). The stationary struts 674 may each be aerodynamically contoured to direct air flowing thereby. Other struts in addition to the stationary struts 674 may be used to connect and support the fan cowl 670 and/or core cowl 622. In many embodiments, the fan duct 672 and the core duct 642 may at least partially co-extend (generally axially) on opposite sides (e.g., opposite radial sides) of the core cowl 622. For example, the fan duct 672 and the core duct 642 may each extend directly from a leading edge 644 of the core cowl 622 and may partially co-extend generally axially on opposite radial sides of the core cowl.

The engine 600 also defines or includes an inlet duct 680. The inlet duct 680 extends between an engine inlet 682 and the annular core inlet 624/fan duct inlet 676. The engine inlet 682 is defined generally at the forward end of the fan cowl 670 and is positioned between the fan 652 and the fan guide vane array 660 along the axial direction A. The inlet duct 680 is an annular duct that is positioned inward of the fan cowl 670 along the radial direction R. Air flowing downstream along the inlet duct 680 is split, not necessarily evenly, into the core duct 642 and the fan duct 672 by a splitter or leading edge 644 of the core cowl 622. The inlet duct 680 is wider than the core duct 642 along the radial direction R. The inlet duct 680 is also wider than the fan duct 672 along the radial direction R.

During operation of the engine 600 at an operating condition, the engine 600 generates a total thrust, Fn_{Total}. The operating condition may be operation of the engine 600 at a rated speed during standard day operating conditions. The total thrust is a sum of a first stream thrust, FN_{1S} (e.g., a primary fan thrust generated by an airflow over the fan cowl 670 and core cowl 622, generated by the fan 652), a third stream thrust, Fn_{2S} (e.g., a thrust generated by an airflow through the fan duct 672 exiting through the fan exhaust nozzle 678, generated at least in part by the ducted fan 684), and a second stream thrust, Fn_{2S} (e.g., a thrust generated by an airflow through the core duct 642 exiting through the turbomachine exhaust nozzle 640).

Notably, for the embodiment depicted, the engine 600 includes one or more features to increase the efficiency of the third-stream thrust, Fn_{3S}. In particular, the engine 600 further includes an array of inlet guide vanes 686 positioned in the inlet duct 680 upstream of the ducted fan 684 and downstream of the engine inlet 682. The array of inlet guide vanes 686 are arranged around the central axis 612. For this embodiment, the inlet guide vanes 686 are not rotatable about the central axis 612. Each inlet guide vanes 686 defines a central blade axis (not labeled for clarity), and is rotatable about their respective central blade axes, e.g., in unison with one another. One or more actuators 668 are provided to facilitate such rotation and therefore may be used to change a pitch of the inlet guide vanes 686 about their respective central blade axes. However, in other embodiments, each inlet guide vanes 686 may be fixed or unable to be pitched about its central blade axis.

Further, located downstream of the ducted fan 684 and upstream of the fan duct inlet 676, the engine 600 includes an array of outlet guide vanes 690. As with the array of inlet guide vanes 686, the array of outlet guide vanes 690 are not rotatable about the central axis 612. However, for the embodiment depicted, unlike the array of inlet guide vanes 686, the array of outlet guide vanes 690 are configured as fixed-pitch outlet guide vanes.

Further, it will be appreciated that for the embodiment depicted, the fan exhaust nozzle 678 of the fan duct 672 is further configured as a variable geometry exhaust nozzle. In such a manner, the engine 600 includes one or more actuators 692 for modulating the variable geometry exhaust nozzle. For example, the variable geometry exhaust nozzle may be configured to vary a total cross-sectional area (e.g., an area of the nozzle in a plane perpendicular to the central axis 612) to modulate an amount of thrust generated based on one or more engine operating conditions (e.g., temperature, pressure, mass flowrate, etc. of an airflow through the fan duct 672). A fixed geometry exhaust nozzle may also be adopted.

The combination of the array of inlet guide vanes 686 located upstream of the ducted fan 684, the array of outlet guide vanes 690 located downstream of the ducted fan 684, and the fan exhaust nozzle 678 may result in a more efficient generation of third-stream thrust, Fn_{3S}, during one or more engine operating conditions. Further, by introducing a variability in the geometry of the inlet guide vanes 686 and the fan exhaust nozzle 678, the engine 600 may be capable of generating more efficient third-stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Referring still to FIG. 6, air passing through the fan duct 672 may be relatively cooler (e.g., lower temperature) than one or more fluids such as air utilized in the turbomachine 620. In this way, one or more heat exchangers 699 may be positioned in thermal communication with the fan duct 672. For example, one or more heat exchangers 699 may be disposed within the fan duct 672 and utilized to cool one or more fluids from the core engine with the air passing through the fan duct 672, as a resource for removing heat from a fluid, e.g., compressor bleed air, oil, or fuel.

Various sensors are shown in FIG. 6. Measurements from these sensors are utilized during ground and/or in-flight testing as has been described elsewhere herein. These sensors are coupled to a controller. The controller can use the sensed information for various purposes and calculations involving the performance of the engine. In some aspects, the sensors can be omitted.

For example, an engine control torque sensor 602 is coupled to the LP shaft 638 to measure torque. At the exit through the fan exhaust nozzle 678, a first pressure sensor 604 (measuring total pressure), a second pressure sensor 606 (measuring static pressure), and a first temperature sensor 608 (measuring total temperature) are deployed. At the turbomachine exhaust nozzle 640, a third pressure sensor 610 (measuring total pressure) and a second temperature sensor 613 (measuring total temperature) are deployed. At the engine inlet 682, a fourth pressure sensor 615 (measuring total pressure), a fifth pressure sensor 617 (measuring static pressure), and a third temperature sensor 618 (measuring total temperature) are deployed. It will be appreciated that other sensors may be deployed at other locations and the sensors can be of the types described or other types.

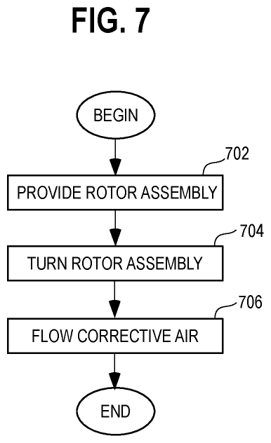

Referring now to FIG. 7, one example of operating a rotor assembly is described.

At step 702, a rotor assembly is provided. The rotor assembly has been described above with respect to FIG. 1.

At step 704, the rotor assembly is rotated to create the airflow 122 to the plurality of rotor blades 102. The airflow 122 has low momentum air along the suction side 118 of each of the plurality of rotor blades 102.

At step 706, a flow of corrective air, referred to herein as corrective airflow 124, moves through the one or more passageways 114 from the pressure side 116 to the suction side 118 of each of the plurality of rotor blades 102. The corrective airflow 124 interacts with and energizes the low momentum air occurring along the suction side 118 of each of the rotor blades 102.

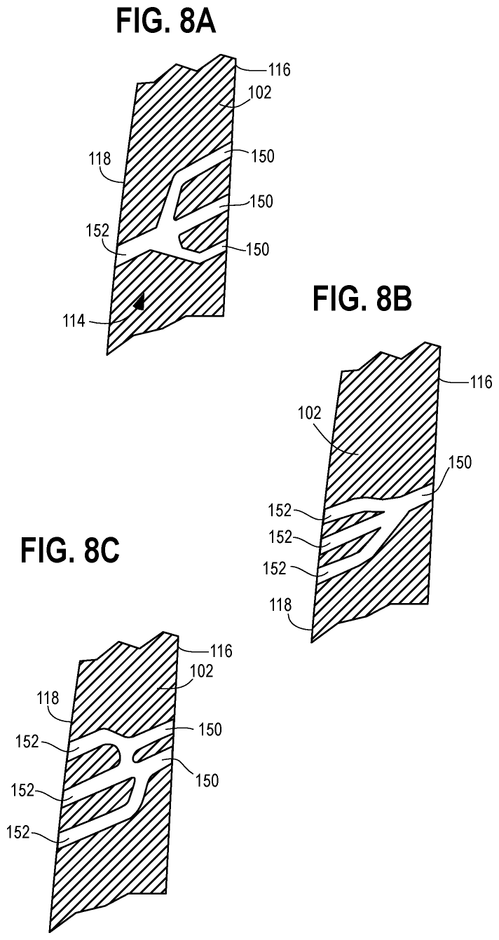

Referring now to FIG. 8A, FIG. 8B, and FIG. 8C, examples of rotor blades having passageways with multiple entrances and/or exits are described.

FIG. 8A illustrates passageway 114 with multiple entrances 150. FIG. 8B illustrates passageway 114 with multiple exits 152. FIG. 8C illustrates passageway 114 with multiple entrances 150 and multiple exits 152. The passageways 114 with multiple entrances 150 and/or exits 152 may be created during the manufacturing process by suitable techniques such as drilling or boring.

The blades provided herein can be used in any type of engine whether the engine is ducted or unducted. In addition, the blades can be used in any type of engine as to whether the engine has a gearbox or operates without a gearbox that, for example, provides for speed reduction. If used with an engine with a gearbox, the blades can be applied to any configuration of gearbox having any operating parameters. The blades can be used as any type of blade used in any engine or any part of the engine including on a rotor. In addition, the blades can be non-rotating stator vanes. When applied to stator vanes and in some aspects, the passageways may be disposed at 0-50% of the span from the hub, but in other aspects may be located at 0-100% of the span from the hub.

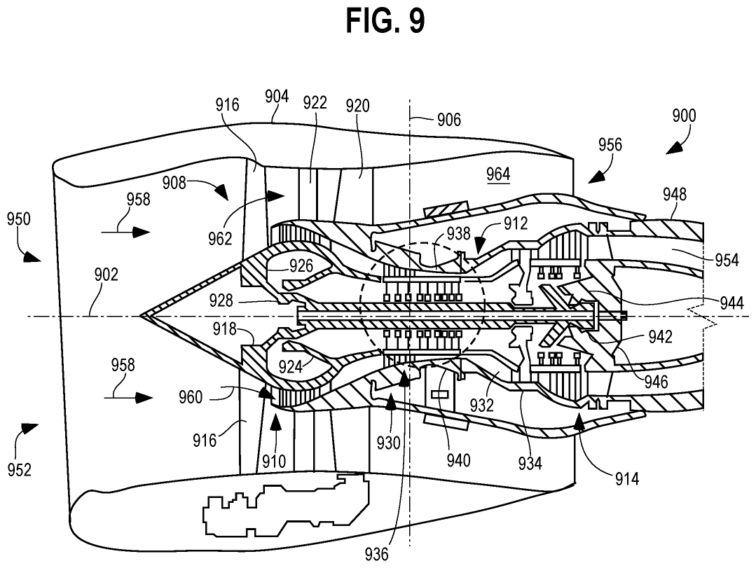

FIG. 9 illustrates an engine assembly 900 (for example an aircraft engine assembly) of a direct drive engine. The engine assembly 900 has a longitudinal axis 902 and an outer stationary annular fan casing 904 disposed concentrically about and coaxially along the longitudinal axis 902. In addition, the engine assembly 900 has a radial axis 906. In one exemplary embodiment, the engine assembly 900 includes a fan assembly 908, a booster compressor 910, an engine 912, and a low-pressure turbine 914 that may be coupled to the fan assembly 908 and the booster compressor 910.

The fan assembly 908 includes a plurality of rotor fan blades 916 that extend substantially radially outward from a fan rotor disk 918 and outlet guide blades (OGVs) 920 for providing aerodynamic function, positioned downstream of the rotor fan blades 916. The fan blades 916 may include one or more passageways as described herein offering the benefits described herein.

Further, the fan assembly 908 includes a plurality of structural strut members 922 for providing structural support. In this example, separate members are used for providing the aerodynamic function and structural support to the outer stationary annular fan casing 904. In other configurations, the OGVs 920 may provide both aerodynamic function and structural support for the outer stationary annular fan casing 904. The booster compressor 910 includes a plurality of rotor blades 924 that extend substantially radially outward from a compressor rotor disk or hub 926 coupled to a first drive shaft 928. The engine 912 includes a compressor 930, a combustor 932, and a turbine 934. In the illustrated embodiment, the compressor 930, the combustor 932, and the turbine 934 are configured in a downstream axial flow relationship. The rotor blades 924 may include one or more passageways as described herein offering the benefits described herein.

The compressor 930 includes a flow path (not labeled in FIG. 9) and a plurality of blades 936 positioned in the flow path, particularly, formed in a hub 938 and a casing 940 of the compressor 930. The plurality of blades 936 may include a rotor blade (not shown in FIG. 9) that may extend substantially radially outward from the hub 938 and a stator blade (not shown in FIG. 9) that may extend substantially radially inward from the casing 940. In one embodiment, the stator blade may be integral part of the casing 940 or may be coupled to the casing 940 via a suitable coupling means such as a cantilever, a hook, and the like. Any of the plurality of blades 936 may include one or more passageways as described herein offering the benefits described herein.

The compressor 930 and the turbine 934 are coupled together by a second drive shaft 942. The first and second drive shafts 928, 942 are rotatably mounted in bearings 944 which are mounted in a fan frame 946 and a turbine rear frame 948. The engine assembly 900 also includes an intake side 950, defining a fan intake 952, an exhaust side 954, and a fan exhaust side 956. In one or more embodiments, the compressor 930 disposed upstream relative to the combustor 932, includes an endwall treatment (not shown in FIG. 9) formed in the casing 940 and the hub 938. As illustrated in the embodiment of FIG. 9, the compressor 930 may be used in the aircraft engine. In certain other embodiments, the compressor 930 may be used in power generation applications, power and water industries, oil and gas refining industries, oil and gas production industries, and a stand-alone compressor without deviating from the scope of the present invention. The compressor 930 is explained in greater detail below.

During operation of the engine assembly 900, the fan assembly 908 compresses a fluid flow 958 (e.g., air) entering the engine assembly 900 through the intake side 950. The fluid flow 958 exiting the fan assembly 908 is split such that a first portion 960 of the fluid flow 958 is channeled into the booster compressor 910, as a compressed fluid flow, and a second portion 962 of the fluid flow 958 bypasses the booster compressor 910 and the engine 912 and exits the engine assembly 900 via a bypass duct 964, through the fan exhaust side 956 as a bypass fluid flow. The plurality of rotor fan blades 924 is configured to compress and deliver the first portion 960 towards the engine 912. Furthermore, the first portion 960 (fluid flow) is further compressed by the compressor 930 and is delivered to the downstream combustor 932. Moreover, the first portion 960 of fluid flow from the combustor 932 drives the rotating turbine 934 and the low-pressure turbine 914 and exits the engine assembly 900 through the engine exhaust side 954.

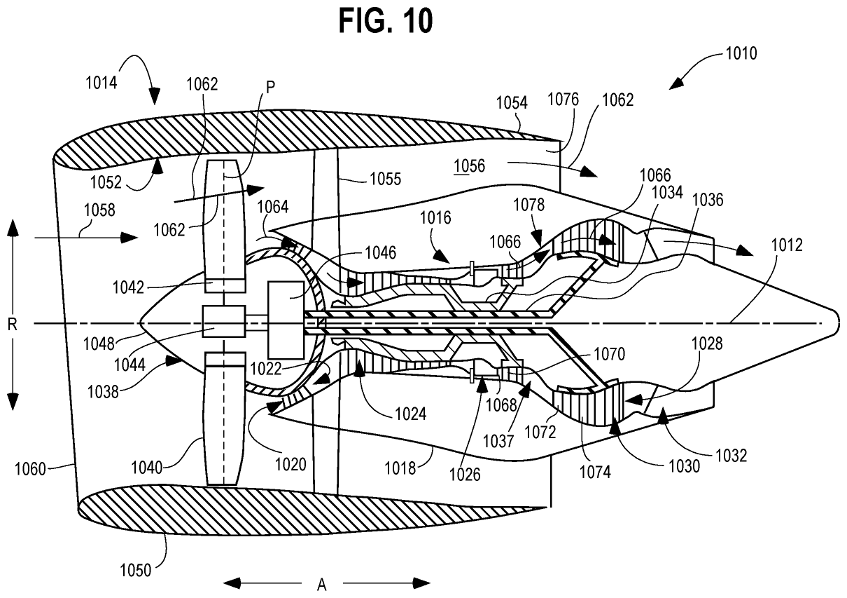

Referring now to FIG. 10, a gas turbine engine including a gearbox is described. More particularly, for the embodiment of FIG. 10, the gas turbine engine is an aeronautical, turbofan jet engine 1010, referred to herein as “turbofan engine 1010”, configured to be mounted to an aircraft, such as in an under-wing configuration or tail-mounted configuration. As shown in FIG. 10, the turbofan engine 1010 defines an axial direction A (extending parallel to a longitudinal centerline 1012 provided for reference), a radial direction R, and a circumferential direction (i.e., a direction extending about the axial direction A; not depicted). In general, the turbofan engine 1010 includes a fan section 1014 and a turbomachine 1016 disposed downstream from the fan section 1014 (the turbomachine 1016 sometimes also, or alternatively, referred to as a “core turbine engine”).

The exemplary turbomachine 1016 depicted generally includes a substantially tubular outer casing 1018 that defines an annular inlet 1020. The outer casing 1018 encases, in serial flow relationship, a compressor section including a first, booster or low-pressure (LP) compressor 1022 and a second, high-pressure (HP) compressor 1024; a combustion section 1026; a turbine section including a first, high-pressure (HP) turbine 1028 and a second, low-pressure (LP) turbine 1030; and a jet exhaust nozzle section 1032. A high-pressure (HP) shaft 1034 drivingly connects the HP turbine 1028 to the HP compressor 1024. A low-pressure (LP) shaft 1036 drivingly connects the LP turbine 1030 to the LP compressor 1022. The compressor section, combustion section 1026, turbine section, and jet exhaust nozzle section 1032 are arranged in serial flow order and together define a core air flowpath 1037 through the turbomachine 1016. It is also contemplated that the present disclosure is compatible with an engine having an intermediate pressure turbine, e.g., an engine having three spools. Any blades associated with the LP compressor 1022 or HP compressor 1024 can include passageways as described herein.

Referring still the embodiment of FIG. 10, the fan section 1014 includes a variable pitch, single stage fan 1038, the turbomachine 1016 operably coupled to the fan 1038 for driving the fan 1038. The fan section 1014 as described with respect to FIG. 10 can also be non-variable (conventional)-pitch.

The fan 1038 includes a plurality of rotatable fan blades 1040 coupled to a disk 1042 in a spaced apart manner. As depicted, the fan blades 1040 extend outwardly from disk 1042 generally along the radial direction R. Each fan blade 1040 is rotatable relative to the disk 1042 about a pitch axis P by virtue of the fan blades 1040 being operatively coupled to a suitable actuation member 1044 configured to collectively vary the pitch of the fan blades 1040, e.g., in unison. The fan blades 1040, disk 1042, and actuation member 1044 are together rotatable about the longitudinal centerline 1012 by LP shaft 1036 across a power gearbox 1046. The fan blades 1040 may have passageways as described elsewhere herein.

The power gearbox 1046 includes a plurality of gears for stepping down the rotational speed of the LP shaft 1036 to a more efficient rotational fan speed. Accordingly, for the embodiment depicted, the turbomachine 1016 is operably coupled to the fan 1038 through the power gearbox 1046.

In exemplary embodiments, the fan section 1014 includes 22 or fewer fan blades 1040. In certain exemplary embodiments, the fan section 1014 includes twenty (20) or fewer fan blades 1040. In certain exemplary embodiments, the fan section 1014 includes eighteen (18) or fewer fan blades 1040. In certain exemplary embodiments, the fan section 1014 includes sixteen (16) or fewer fan blades 1040. In certain exemplary embodiments, it is contemplated that the fan section 1014 includes another number of fan blades 1040 for a particular application.

During operation of the turbofan engine 1010, the fan 1038 defines a fan pressure ratio and the plurality of fan blades 1040 each define a fan tip speed. As will be described in greater detail below, the exemplary turbofan engine 1010 depicted defines a relatively high fan tip speed and relatively low fan pressure ratio during operation of the turbofan engine at a rated speed. As used herein, the term “fan pressure ratio” refers to a ratio of an air pressure immediately downstream of the fan blades 1040 during operation of the fan 1038 to an air pressure immediately upstream of the fan blades 1040 during operation of the fan 1038. For the embodiment depicted in FIG. 10, the fan 1038 of the turbofan engine 1010 defines a relatively low fan pressure ratio. For example, the turbofan engine 1010 depicted defines a fan pressure ratio less than or equal to about 1.5. For example, in certain exemplary embodiments, the turbofan engine 1010 may define a fan pressure ratio less than or equal to about 1.4. The fan pressure ratio may be the fan pressure ratio of the fan 1038 during operation of the turbofan engine 1010, such as during operation of the turbofan engine 1010 at a rated speed.

As used herein, the term “rated speed” with reference to the turbofan engine 1010 refers to a maximum rotational speed that the turbofan engine 1010 may achieve while operating properly. For example, the turbofan engine 1010 may be operating at the rated speed during maximum load operations, such as during takeoff operations.

Also as used herein, the term “fan tip speed” defined by the plurality of fan blades 1040 refers to a linear speed of an outer tip of a fan blade 1040 along the radial direction R during operation of the fan 1038. In exemplary embodiments, the turbofan engine 1010 of the present disclosure causes the fan blades 1040 of the fan 1038 to rotate at a relatively high rotational speed. For example, during operation of the turbofan engine 1010 at the rated speed, the fan tip speed of each of the plurality of fan blades 1040 is greater than or equal to 1000 feet per second and less than or equal to 2250 feet per second. In certain exemplary embodiments, during operation of the turbofan engine 1010 at the rated speed, the fan tip speed of each of the fan blades 1040 may be greater than or equal to 1,250 feet per second and less than or equal to 2250 feet per second. In certain exemplary embodiments, during operation of the turbofan engine 1010 at the rated speed, the fan tip speed of each of the fan blades 1040 may be greater than or equal to about 1,350 feet per second, such as greater than about 1,450 feet per second, such as greater than about 1,550 feet per second, and less than or equal to 2250 feet per second.

Referring still to the exemplary embodiment of FIG. 10, the disk 1042 is covered by a rotatable front nacelle or hub 1048, aerodynamically contoured to promote an airflow through the plurality of fan blades 1040. Additionally, the exemplary fan section 1014 includes an annular fan casing or outer nacelle 1050 that at least partially, and for the embodiment depicted, circumferentially, surrounds the fan 1038 and at least a portion of the turbomachine 1016.

More specifically, the nacelle 1050 includes an inner wall 1052 and a downstream section 1054 of the inner wall 1052 of the nacelle 1050 extends over an outer portion of the turbomachine 1016 so as to define a bypass airflow passage 1056 therebetween. Additionally, for the embodiment depicted, the nacelle 1050 is supported relative to the turbomachine 1016 by a plurality of circumferentially spaced outlet guide vanes 1055.

During operation of the turbofan engine 1010, a volume of air 1058 enters the turbofan engine 1010 through an associated inlet 1060 of the nacelle 1050 and/or fan section 1014. As the volume of air 1058 passes across the fan blades 1040, a first portion of the air 1058 as indicated by arrows 1062 is directed or routed into the bypass airflow passage 1056 and a second portion of the air 1058 as indicated by arrow 1064 is directed or routed into the core air flowpath 1037. The ratio between an amount of airflow through the bypass airflow passage 1056 (i.e., the first portion of air indicated by arrows 1062) to an amount of airflow through the core air flowpath 1037 (i.e., the second portion of air indicated by arrow 1064) is known as a bypass ratio.

In exemplary embodiments, the bypass ratio during operation of the turbofan engine 1010 (e.g., at a rated speed) is less than or equal to about eleven (1011). For example, the bypass ratio during operation of the turbofan engine 1010 (e.g., at a rated speed) may be less than or equal to about ten (10), such as less than or equal to about nine (9). Additionally, the bypass ratio may be at least about two (2).

In other exemplary embodiments, the bypass ratio may generally be between about 7:1 and about 20:1, such as between about 10:1 and about 18:1. The pressure of the second portion of air indicated by arrow 1064 is then increased as it is routed through the HP compressor 1024 and into the combustion section 1026, where it is mixed with fuel and burned to provide combustion gases 1066.

In exemplary embodiments, a gear ratio of the power gearbox 1046 is greater than or equal to 1.2 and less than or equal to 3.0. In some exemplary embodiments, the gear ratio of the power gearbox 1046 is greater than or equal to 1.2 and less than or equal to 2.6. In other exemplary embodiments, the gear ratio of the power gearbox 1046 is greater than or equal to 1.2 and less than or equal to 2.0.

It should be appreciated that the exemplary turbofan engine described operates contrary to conventional teachings. Specifically, conventional engine operation teachings generally attempt to minimize fan speed with such gear ratios. For example, conventional engine operation teach low fan speeds for better efficiencies. However, the turbofan engine 1010 described herein operates contrary to these teachings by reducing the gear ratio while operating at a high fan tip speed, while maintaining a relatively low fan pressure ratio. The turbofan engine of the present disclosure achieves improved system efficiencies by enabling higher fan tip speeds at lower fan pressure ratios. Furthermore, the turbofan engine of the present disclosure also provides pre-swirling flow forward of the fan blade tip as described herein.

Referring still to FIG. 10, the compressed second portion of air indicated by arrow 1064 from the compressor section mixes with fuel and is burned within the combustion section to provide combustion gases 1066. The combustion gases 1066 are routed from the combustion section 1026, through the HP turbine 1028 where a portion of thermal and/or kinetic energy from the combustion gases 1066 is extracted via sequential stages of HP turbine stator vanes 1068 that are coupled to the outer casing 1018 and HP turbine rotor blades 1070 that are coupled to the HP shaft 1034, thus causing the HP shaft 1034 to rotate, thereby supporting operation of the HP compressor 1024. The combustion gases 1066 are then routed through the LP turbine 1030 where a second portion of thermal and kinetic energy is extracted from the combustion gases 1066 via sequential stages of LP turbine stator vanes 1072 that are coupled to the outer casing 1018 and LP turbine rotor blades 1074 that are coupled to the LP shaft 1036, thus causing the LP shaft 1036 to rotate, thereby supporting operation of the LP compressor 1022 and/or rotation of the fan 1038.

The combustion gases 1066 are subsequently routed through the jet exhaust nozzle section 1032 of the turbomachine 1016 to provide propulsive thrust.

Simultaneously, the pressure of the first portion of air indicated by arrows 1062 is substantially increased as the first portion of air indicated by arrows 1062 is routed through the bypass airflow passage 1056 before it is exhausted from a fan nozzle exhaust section 1076 of the turbofan engine 1010, also providing propulsive thrust. The HP turbine 1028, the LP turbine 1030, and the jet exhaust nozzle section 1032 at least partially define a hot gas path 1078 for routing the combustion gases 1066 through the turbomachine 1016.

In some exemplary embodiments, it will be appreciated that the exemplary turbofan engine 1010 of the present disclosure may be a relatively large power class turbofan engine 1010. Accordingly, when operated at the rated speed, the turbofan engine 1010 may be configured to generate a relatively large amount of thrust. More specifically, when operated at the rated speed, the turbofan engine 1010 may be configured to generate at least about 20,000 pounds of thrust, such as at least about 25,000 pounds of thrust, such as at least about 30,000 pounds of thrust. Accordingly, the turbofan engine 1010 may be referred to as a relatively large power class gas turbine engine.

Moreover, it should be appreciated that the exemplary turbofan engine 1010 depicted in FIG. 10 is by way of example only, and that in other exemplary embodiments, the turbofan engine 1010 may have any other suitable configuration. For example, in certain exemplary embodiments, the fan may not be a variable pitch fan. Additionally, or alternatively, aspects of the present disclosure may be utilized with any other suitable aeronautical gas turbine engine, such as a turboshaft engine, turboprop engine, turbojet engine, etc.

Further aspects of the disclosure are provided by the subject matter of the following clauses:

A rotor blade, the rotor blade comprising: an elongated body, the elongated body comprising a pressure side and a suction side, the pressure side and suction side intersecting at a leading edge and a trailing edge, the elongated body having a root that is coupled to a rotor hub, the elongated body extending outward from the rotor hub, wherein a span of the elongated body is described by a first straight line distance extending outward from the rotor hub along the elongated body to a tip surface, wherein a chord of the elongated body is defined by a second straight-line distance extending between the leading edge and the trailing edge; one or more passageways extending through the elongated body between the pressure side and the suction side, the one or more passageways allowing a corrective flow of air to move from the pressure side to the suction side, the corrective flow of air interacting with and energizing low momentum air occurring along the suction side.

The rotor blade of any of the preceding clauses, wherein each of the one or more passageways of the rotor blade is located at a distance greater than 40 percent span from the rotor hub.

The rotor blade of any of the preceding clauses, wherein each of the one or more passageways of the rotor blade is located at a distance of up to 40 percent along the chord.

The rotor blade of any of the preceding clauses, wherein each of the one or more passageways of the rotor blade is located at a distance of greater than 50 percent along the chord.

The rotor blade of any of the preceding clauses, wherein an angle of each of the one or more passageways is described with respect to a line tangent to a point on the suction side and the angle is from 5 degrees to 175 degrees.

The rotor blade of any of the preceding clauses, wherein the one or more passageways comprises a single passageway.

The rotor blade of any of the preceding clauses, wherein the one or more passageways comprises multiple passageways.

The rotor blade of any of the preceding clauses, wherein the one or more passageways includes multiple inlets, outlets, or both.

A rotor assembly disposed in an aircraft propulsion device, the rotor assembly comprising: a rotor hub; a plurality of rotor blades extending outward from the rotor hub; wherein each of the plurality of rotor blades comprises: an elongated body, the elongated body comprising a pressure side and a suction side, the pressure side and suction side intersecting at a leading edge and a trailing edge, the elongated body having a root that is coupled to the rotor hub, the elongated body extending outward from the rotor hub, wherein a span of the elongated body is described by a first straight line distance extending outward from the rotor hub along the elongated body to a tip surface, wherein a chord of the elongated body is defined by a second straight-line distance extending between the leading edge and the trailing edge; one or more passageways extending through the elongated body between the pressure side and the suction side, the one or more passageways allowing a corrective flow of air to move from the pressure side to the suction side, the corrective flow of air interacting with and energizing low momentum airflow occurring along the suction side.

The rotor assembly of any of the preceding clauses, wherein each of the one or more passageways of each rotor blade is located at a distance greater than 40 percent span from the rotor hub.

The rotor assembly of any of the preceding clauses, wherein each of the one or more passageways of each rotor blade is located at a distance of up to 40 percent along the chord.

The rotor assembly of any of the preceding clauses, wherein each of the one or more passageways of each rotor blade is located at a distance of greater than 50 percent along the chord.

The rotor assembly of any of the preceding clauses, wherein an angle of each of the one or more passageways of each of the plurality of rotor blades is described with respect to a line tangent to a point on the suction side and the angle is from 5 degrees to 175 degrees.

The rotor assembly of any of the preceding clauses, wherein each of the one or more passageways of each the plurality of rotor blades comprises a single passageway.

The rotor assembly of any of the preceding clauses, wherein each of the one or more passageways of each of the plurality of rotor blades comprises multiple passageways.

The rotor assembly of any of the preceding clauses, wherein the rotor assembly is deployed in an unducted propulsion device.

The rotor assembly of any of the preceding clauses, wherein the rotor assembly is deployed in a ducted propulsion device.

The rotor assembly of any of the preceding clauses, wherein the one or more passageways includes multiple inlets, outlets, or both.

A method of operating a rotor assembly, the method comprising: providing a rotor assembly, the rotor assembly comprising a rotor hub and a plurality of rotor blades extending outward from the rotor hub, wherein each of plurality of rotor blades comprises an elongated body, the elongated body comprising a pressure side and a suction side, the pressure side and suction side intersecting at a leading edge and a trailing edge, the elongated body having a root that is coupled to the rotor hub, the elongated body extending outward from the rotor hub, wherein a span of the elongated body is described by a first straight line distance extending outward from the rotor hub along the elongated body to a tip surface, wherein a chord of the elongated body is defined by a second straight-line distance extending between the leading edge and the trailing edge, each rotor blade comprising one or more passageways extending through the elongated body between the pressure side and the suction side; turning the rotor assembly to create at some conditions an airflow to the plurality of rotor blades, the airflow having low momentum air along the suction side of each of the plurality of rotor blades; and allowing a flow of corrective air to move through the one or more passageways from the pressure side to the suction side of each of the plurality of rotor blades, the corrective air interacting with and energizing the low momentum air occurring along the suction side of each of the rotor blades.

The method of any of the preceding clauses, wherein each of the one or more passageways of each rotor blade is located at a distance greater than 40 percent span from the rotor hub.

The method of any of the preceding clauses, wherein each of the one or more passageways of each rotor blade is located at a distance of up to 40 percent along the chord.

The method of any of the preceding clauses, wherein each of the one or more passageways of each rotor blade is located at a distance of greater than 50 percent along the chord.

The method of any of the preceding clauses, wherein the one or more passageways includes multiple inlets, outlets, or both.

An engine with a rotor assembly, the rotor assembly comprising: a rotor hub; a plurality of rotor blades extending outward from the rotor hub; wherein each of the plurality of rotor blades comprises: an elongated body, the elongated body comprising a pressure side and a suction side, the pressure side and suction side intersecting at a leading edge and a trailing edge, the elongated body having a root that is coupled to the rotor hub, the elongated body extending outward from the rotor hub, wherein a span of the elongated body is described by a first straight line distance extending outward from the rotor hub along the elongated body to a tip surface, wherein a chord of the elongated body is defined by a second straight-line distance extending between the leading edge and the trailing edge; one or more passageways extending through the elongated body between the pressure side and the suction side, the one or more passageways allowing a corrective flow of air to move from the pressure side to the suction side, the corrective flow of air interacting with and energizing low momentum airflow occurring along the suction side.

The engine of any of the preceding clauses, wherein each of the one or more passageways of each rotor blade is located at a distance greater than 40 percent span from the rotor hub.

The engine of any of the preceding clauses, wherein each of the one or more passageways of each rotor blade is located at a distance of up to 40 percent along the chord.

The engine of any of the preceding clauses, wherein each of the one or more passageways of each rotor blade is located at a distance of greater than 50 percent along the chord.

The engine of any of the preceding clauses, wherein an angle of each of the one or more passageways of each of the plurality of rotor blades is described with respect to a line tangent to a point on the suction side and the angle is from 5 degrees to 175 degrees.

The engine of any of the preceding clauses, wherein each of the one or more passageways of each the plurality of rotor blades comprises a single passageway.

The engine of any of the preceding clauses, wherein each of the one or more passageways of each of the plurality of rotor blades comprises multiple passageways.

The engine of any of the preceding clauses, wherein the rotor assembly is deployed in an unducted propulsion device.

The engine of any of the preceding clauses, wherein the rotor assembly is deployed in a ducted propulsion device.

The engine of any of the preceding clauses, wherein the one or more passageways includes multiple inlets, outlets, or both.

Those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

1. A rotor blade, the rotor blade comprising:
an elongated body, the elongated body comprising a pressure side and a suction side, the pressure side and suction side intersecting at a leading edge and a trailing edge, the elongated body having a root that is coupled to a rotor hub, the elongated body extending outward from the rotor hub in a radial direction, wherein a span of the elongated body is described by a first straight line distance extending outward from the rotor hub along the elongated body to a tip surface, wherein a chord of the elongated body is defined by a second straight-line distance extending between the leading edge and the trailing edge;
wherein the suction side comprises a continuous surface over which external air flows;
one or more passageways extending through the elongated body between the pressure side and the suction side, the one or more passageways being substantially straight and positioned in a generally perpendicular direction with respect to the pressure side and the suction side and not being skewed in the radial direction, the one or more passageways allowing a corrective flow of air to move from the pressure side to the suction side and exit the blade in a direction that is substantially perpendicular to the suction side and not skewed in the radial direction, the corrective flow of air interacting with and energizing low momentum air occurring along the suction side.

2. The rotor blade of claim 1, wherein each of the one or more passageways of the rotor blade is located at a distance greater than 40 percent of the span from the rotor hub.

3. The rotor blade of claim 1, wherein each of the one or more passageways of the rotor blade is located at a distance of up to 40 percent along the chord.

4. The rotor blade of claim 1, wherein each of the one or more passageways of the rotor blade is located at a distance of greater than 50 percent along the chord.

5. The rotor blade of claim 1, wherein an angle of each of the one or more passageways is described with respect to a line tangent to a point on the suction side and the angle is from 5 degrees to 175 degrees.

6. The rotor blade of claim 1, wherein the one or more passageways comprises a single passageway.

7. The rotor blade of claim 1, wherein the one or more passageways comprises multiple passageways.

8. A rotor assembly disposed in an aircraft propulsion device, the rotor assembly comprising:
a rotor hub; and
a plurality of rotor blades extending outward from the rotor hub,
wherein each of the plurality of rotor blades comprises:
an elongated body, the elongated body comprising a pressure side and a suction side, the pressure side and suction side intersecting at a leading edge and a trailing edge, the elongated body having a root that is coupled to the rotor hub, the elongated body extending outward from the rotor hub in a radial direction, wherein a span of the elongated body is described by a first straight line distance extending outward from the rotor hub along the elongated body to a tip surface, wherein a chord of the elongated body is defined by a second straight-line distance extending between the leading edge and the trailing edge;
wherein the suction side comprises a continuous surface over which external air flows;
one or more passageways extending through the elongated body between the pressure side and the suction side, the one or more passageways being substantially straight and positioned in a generally perpendicular direction with respect to the pressure side and the suction side and not being skewed in the radial direction, the one or more passageways allowing a corrective flow of air to move from the pressure side to the suction side and exit the blade in a direction that is substantially perpendicular to the suction side and not skewed in the radial direction, the corrective flow of air interacting with and energizing low momentum airflow occurring along the suction side.

9. The rotor assembly of claim 8, wherein each of the one or more passageways of each rotor blade is located at a distance greater than 40 percent span from the rotor hub.

10. The rotor assembly of claim 8, wherein each of the one or more passageways of each rotor blade is located at a distance of up to 40 percent along the chord.

11. The rotor assembly of claim 8, wherein each of the one or more passageways of each rotor blade is located at a distance of greater than 50 percent along the chord.

12. The rotor assembly of claim 8, wherein an angle of each of the one or more passageways of each of the plurality of rotor blades is described with respect to a line tangent to a point on the suction side and the angle is from 5 degrees to 175 degrees.

13. The rotor assembly of claim 8, wherein each of the one or more passageways of each the plurality of rotor blades comprises a single passageway.

14. The rotor assembly of claim 8, wherein each of the one or more passageways of each of the plurality of rotor blades comprises multiple passageways.

15. The rotor assembly of claim 8, wherein the rotor assembly is deployed in an unducted propulsion device.

16. The rotor assembly of claim 8, wherein the rotor assembly is deployed in a ducted propulsion device.

17. A method of operating a rotor assembly, the method comprising:
providing a rotor assembly, the rotor assembly comprising a rotor hub and a plurality of rotor blades extending outward from the rotor hub in a radial direction, wherein each of plurality of rotor blades comprises an elongated body, the elongated body comprising a pressure side and a suction side, the pressure side and suction side intersecting at a leading edge and a trailing edge, the elongated body having a root that is coupled to the rotor hub, the elongated body extending outward from the rotor hub, wherein a span of the elongated body is described by a first straight line distance extending outward from the rotor hub along the elongated body to a tip surface, wherein a chord of the elongated body is defined by a second straight-line distance extending between the leading edge and the trailing edge, wherein the suction side comprises a continuous surface over which external air flows, each rotor blade comprising one or more passageways extending through the elongated body between the pressure side and the suction side, the one or more passageways being substantially straight and positioned in a generally perpendicular direction with respect to the pressure side and the suction side and not being skewed in the radial direction;
turning the rotor assembly to create at some conditions an airflow to the plurality of rotor blades, the airflow having low momentum air along the suction side of each of the plurality of rotor blades; and
allowing a flow of corrective air to move through the one or more passageways from the pressure side to the suction side of each of the plurality of rotor blades and exit the blade in a direction that is substantially perpendicular to the suction side and not skewed in the radial direction, the corrective air interacting with and energizing the low momentum air occurring along the suction side of each of the rotor blades.

18. The method of claim 17, wherein each of the one or more passageways of each rotor blade is located at a distance greater than 40 percent span from the rotor hub.

19. The method of claim 17, wherein each of the one or more passageways of each rotor blade is located at a distance of up to 40 percent along the chord.

20. The method of claim 17, wherein each of the one or more passageways of each rotor blade is located at a distance of greater than 50 percent along the chord.
